(19) United States
(12) Patent Application Publication
(10) Pub. No.: US 2003/0183327 A1
(43) Pub. Date: Oct. 2, 2003

(54) PROCESS AND DEVICE FOR CLADDING SELF- ADHESIVE FILM SHEETS

(76) Inventor: Michael Titze, Haan (DE)

Correspondence Address: HARNESS, DICKEY & PIERCE, P.L.C., P.O. BOX 828, BLOOMFIELD HILLS, MI, 48303, US

(21) Appl. No.: 10/221,687

(22) PCT Filed: Mar. 13, 2001
(86) PCT No.: PCT/EP01/02789

(30) Foreign Application Priority Data
Mar. 17, 2000 (DE) 100 13 224.3

(51) Int. Cl. B32B 31/00

(52) U.S. Cl. 156/212; 156/285; 156/486; 156/581

(57) ABSTRACT

The invention relates to a process for positionally precise cladding of film sheets (4), with self-adhesive coatings on their backside (4a), onto parts (2) to be glued, especially car body components. The respective film sheet (4), in a convexly curved state of its self-adhesive backside, is pre-positioned into a defined orientation and then clad, by means of a determinately controlled pressure and rolling motion, onto the respective part (2) to be glued, which is fixed in a defined arrangement.

### FIELD OF THE INVENTION

The present invention relates to a process for cladding film sheets with self-adhesive coatings on their backside onto parts that are to be glued, especially car body components in accordance with the preamble of claim 1.

The invention furthermore according to claim 10 relates to a novel device for automatically cladding self-adhesive film sheets, especially for executing the process in accordance with the invention.

### BACKGROUND OF THE INVENTION

DE-GM 29907231 describes a self-adhesive sheet of molding. Such sheets are used to line body components in the automotive industry for example, and frequently used for A, B, and/or C-pillars on a car's exterior. There they make an aesthetically attractive and protective decoration of the component's surface. The sheets are blanked out of film webs, particularly strip-like lengthwise, punched in particular, with a shape that has been fit to the component to be glued. Here the film sheet mainly consists of plastic, PVC in particular.

The sheets must be clad very exactly, positionally accurate and wrinkle-free, which has only been possible manually up to now. But this work demands a large expenditure of time and labor and is consequently associated with relatively high production costs. In addition, the precision depends on the care taken by the respective worker, so that the required repeat accuracy (process control) can only be conditionally achieved.

U.S. Pat. No. 5,733,410 specifies a device for the application of adhesive labels on flat surfaces of specific articles. This device has a labeling head comprising a convex application surface on which the respective label is fixed by means of vacuum suction. The labeling head is supported at one end by a bearing pin in such a manner that its other end can be pivoted against a spring. Together with the labeling head, the support can be exclusively moved vertically, perpendicular to the horizontally positioned article surface being labeled, by means of a pneumatic cylinder. The result of this is that one side of the adhesive label is first pressed on by a downward motion of the labeling head and then applied flatly by means of the labeling head automatically rotating solely from the vertical motion. Actually, this results in a relative frictional motion of the convex surface of the labeling head on the flat article surface being labeled such that sliding-like creases can occur particularly when applying large labels. This known device might therefore be only suitable for smaller adhesive labels. Also, the vacuum suction causes arching to such an extent in the label that resultant air bubbles are captured. Overall, therefore, accuracy leaves something to be desired with this known device. In addition, it is restricted to an application with horizontally positioned adhesive surfaces.

DE-A-28 53 033 specifies a device for producing film vehicle identification plates. The sections of film are first taken from a course of double film by means of a drum and then rolled onto a plate, the plate being moved beneath the rotating drum. The sections of film are fixed onto the drum by vacuum. Here, too, there is the disadvantage that, during application, air bubbles can be created in the area of the suction holes in the drum. In addition, here, too, the device is restricted to a horizontal arrangement of the parts (sheet metal parts) being labeled.

### SUMMARY OF THE INVENTION

It is the objective of the present invention to present a process by which the described work operation of gluing film sheets with a positionally accurate labeling application can be carried out economically, with little labor, time and, in particular, irrespective of the spatial orientation of the part being labeled, but still with high accuracy (exact positioning, wrinkle-free). Furthermore, a structurally simple and inexpensive device with high process control shall also be created to execute the process. To do this, the application mechanism is mechanically controlled in a three-dimensional motion (in three coordinates of space) in such a manner according to the invention that a clean, friction-free rolling motion is achieved on the surface being labeled, or over the surface. This involves not only a simple rotating motion of the application mechanism about only a specific pivot during a concurrent linear feed/pressing motion, but much more a special three-dimensionally controlled motion each time about a “virtual” dynamically progressing axis of rotational motion that is always positioned in an approximately tangential point of contact (line of contact) between the component and the convex mounting surface (or the section of film positioned on it) and therefore travels over the component in a progressive rolling motion. In this way, a frictional relative motion between the component and the convex mounting surface in, or on, the surface being labeled is advantageously totally precluded, which assures a smooth, crease-free application of the cut section of film.

In accordance with the invention, this is first achieved with a process as recited in claim 1. Accordingly, the film sheet of interest is positioned with its self-adhesive backside opposite the front side, into a defined orientation on a convexly curved mating surface of an application device and then clad, by means of a determinately, spatially, mechanically controlled pressure and rolling motion of the mating surface of the application device, onto the corresponding part to be glued, which is fixed in a defined arrangement relative to the application device. The movement in accordance with the invention of the application device, or of the mating surface with the film sheet precisely pre-positioned upon it, resembles a rocking seesawing motion of a formerly common ink blotter. It is therefore preferably possible to clad the film sheet very precisely and wrinkle-free in an automated process. It is suitable to use a numerically controlled robot for this, so that the cladding is executed with very precise motion control with high repeat accuracy (process control).

In addition to that, the invention also provides for the fully random spatial orientation of the surface being labeled. This means that the surface need not be positioned horizontally, but, for example, can also be oriented somewhat vertically or randomly otherwise spatially. This represents a particular advantage with regard to the preferred application of the invention in the automotive industry because any body surfaces can be provided with decorative film directly on the assembly line. In addition to that, the independently controllable motion also permits matching to specific surface contours of the component (contour independence).

A device in accordance with the invention is distinguished by the characteristics of claim 10. Preferable further developments of the invention are contained in the claims dependent on claims 1 and 10, respectively.

### BRIEF DESCRIPTION OF THE DRAWINGS

The invention will be explained in more detail by examples based on the drawing, wherein a preferred example of a device in accordance with the invention is represented in different states while the process in accordance with the invention is being executed. The individual figures show:

FIG. 1 perspective side view of a device in accordance with the invention with a robot-controlled application device,

FIG. 2 plan view of a car door to be glued, in the region of a B-pillar for the sake of an example, in the direction of arrow II of FIG. 1,

FIG. 3 cross section through the door of plane III-III of FIG. 2,

FIG. 4 plan view of the mating surface of the application device together with a film sheet still illustrated separately,

FIG. 5 view as in FIG. 4, with the film sheet pre-positioned on the mating surface while a positioning section and a protective layer arranged on the self-adhesive backside (cover foil/silicone paper, or the like) are being removed,

FIG. 6 partial view analogous to FIG. 1 while an actual application operation is beginning,

FIG. 7 view as in FIG. 6 during the application device's rocking and seesawing movements,

FIG. 8 an optional rolling action carried out by an extra pressure roller of the application device,

FIG. 9 cross section IX-IX in accordance with FIG. 8 to illustrate the action while a side strip (so-called welt) of the film sheet is turned over,

FIG. 10 view similar to FIG. 9 to fold the side strip approximately 180°, and

FIG. 11 plan view as in FIG. 2 onto the completely glued door.

### DETAILED DESCRIPTION OF THE PREFERRED EMBODIMENTS

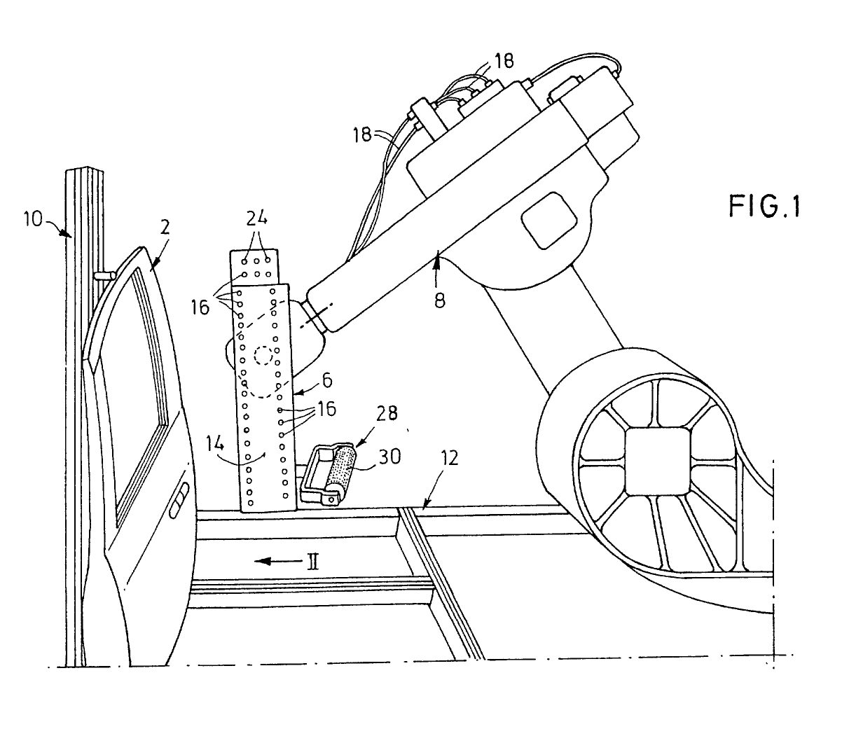

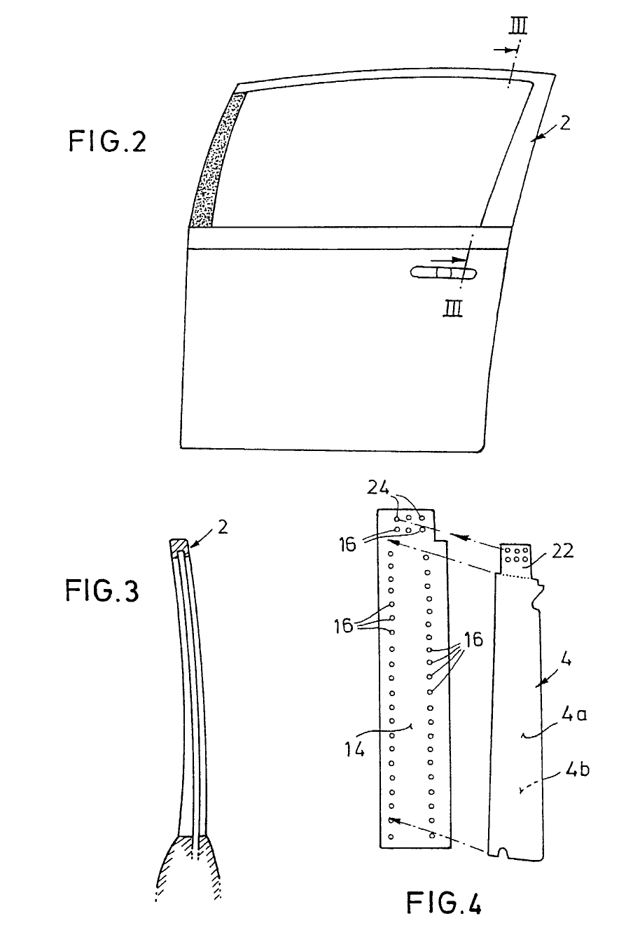

In accordance with FIG. 1, a part 2 (in this example, a car door in the region of a cross-beam, such as the B-pillar) is supposed to be glued with a film sheet 4 (see FIG. 4 in particular). For this, the film sheet 4 is self-adhesive on its backside 4a, i.e. is coated with a pressure-sensitive bonding emulsion, whereas its opposite front side 4b forms a decorative surface.

As is furthermore seen in FIG. 1, a device in accordance with the invention features an application device 6 to automatically clad film sheet 4 onto part 2 with positional precision. A robotic arm 8 preferably guides and precisely controls its movements in three-dimensional space. In practice, the application device 6 thus forms a “hand” of robotic arm 8. The part 2 to be glued can be fixed in a defined alignment relative to the application device 6, and appropriate holding means 10 are arranged in a defined arrangement relative to the robotic arm 8 for this purpose, fastened to a mutual machine frame 12 for example.

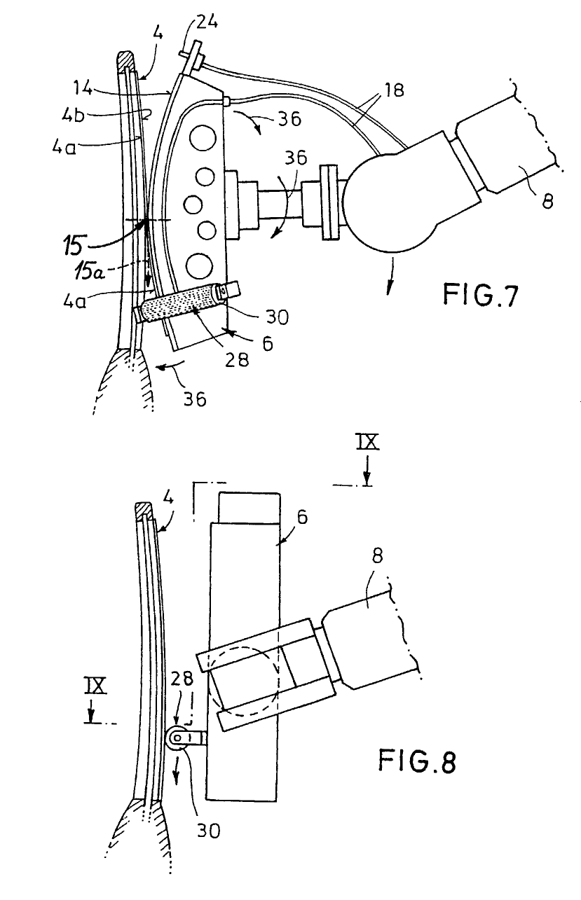

The application device 6 features a convexly curved mating surface 14, which is determinately aligned and fixed to fit the corresponding film sheet 4. The shape of the mating surface 14 is adapted to the shape of film sheet 4. In the illustrated example, film sheet 4 is oblong and designed long and rectangular in the widest sense, so that the mating surface 14 likewise has a corresponding, but somewhat larger oblong rectangular shape. Since the mating surface 14 is only designed as curved in the direction of one axis, the surface's longitudinal axis to be particular, but is designed straight perpendicular to that axis (in the transverse direction), the result is a contact rolling or rocker surface like that of a rocker blotter formerly used as an ink blotter. The corresponding film sheet 4 can be fixed onto the mating surface 14, by vacuum suction in particular, and indeed in an alignment in which its decorative front side 4b rests on the mating surface 14 and its backside 4a, coated with self-adhesive, is openly pointed forwards away from mating surface 14. In accordance with the invention, the application device 6 can be three-dimensionally, mechanically controlled relative to the part 2 to be glued in such a way that film sheet 4 can be clad clean, i.e. friction-free to part 2 by a pressure and rolling motion of the mating surface 14. This operation is illustrated in FIGS. 6 and 7 in particular.

Consequently, the rolling motion does not occur only about a specific pivot axis of the application mechanism 6, but in each case about a “virtual” dynamically progressing axis of rotational motion 15 over the component 2 (see FIG. 6 and 7), whereby the progressing axis of rotational motion 15, during the rolling motion, always coincides with an essentially linear zone of contact resulting between the component 2 and the cut section of film 4 arranged on the convex mounting surface 14. In this contact zone, the component 2 and the mounting surface 14, between which is positioned the cut film section 4, are approximately tangentially adjacent to each other. The result of this motion control of the application mechanism 6 according to invention is that every relative motion and friction resulting thereby is advantageously precluded on the surface being labeled because the application mechanism rolls solely on the component 2. As a result, the cut section of film 4 is applied very accurately and totally free of creases.

A programmable control unit, not illustrated in the drawing, is provided for motion control of the robotic arm 8 and application device 6. We can be dealing with conventional computerized numerical control.

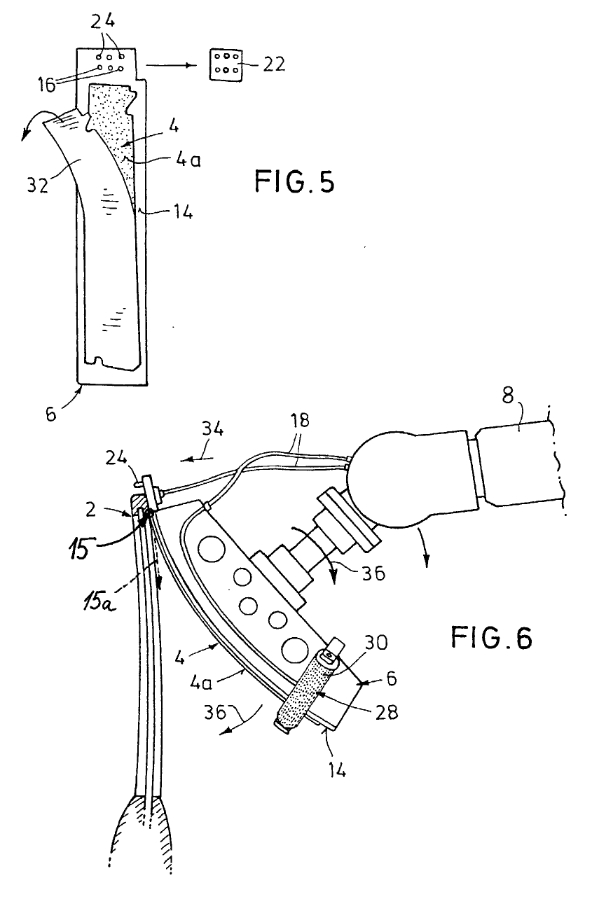

The means for the vacuum suction already mentioned consist of vacuum suction holes 16 near the mating surface 14, whereby the suction holes 16 can be connected to an unillustrated vacuum pump by lines 18. The holes are also arranged over the mating surface 14 with a particular distribution. It is particularly advantageous for the suction holes 16 to be arranged only in the region of the edge strips 20 of film sheet 4, whereby these edge strips 20 still project beyond the edges of part 2 after the application device 6 has performed the first cladding onto part 2 by means of the pressure and rolling motion in accordance with the invention, i.e. they lie outside the first surface glued. The vacuum suction only occurs in the region of the edge strips 20, thereby advantageously preventing vaults of the film sheet in the first surface region to be glued. These vaults could otherwise lead to blistering. High precision is therefore achieved. In addition, more suction holes 16 are located in the region of a positioning section 22 of film sheet 4, which is arranged on the narrow side, whereby this positioning section 22 can be removed (see FIG. 5) after film sheet 4 has been exactly fixed into position. Moreover, alignment means 24 (pin-shaped in particular) are arranged on mating surface 14 in this region, and film sheet 4 can be hung onto them with positioning section 22 for pre-alignment.

The mating surface 14 of the application device 6 is preferably made of a flexible deformable layer 26, especially of a silicone cushion or other suitable plastic. This also contributes to a qualitatively superior bonding.

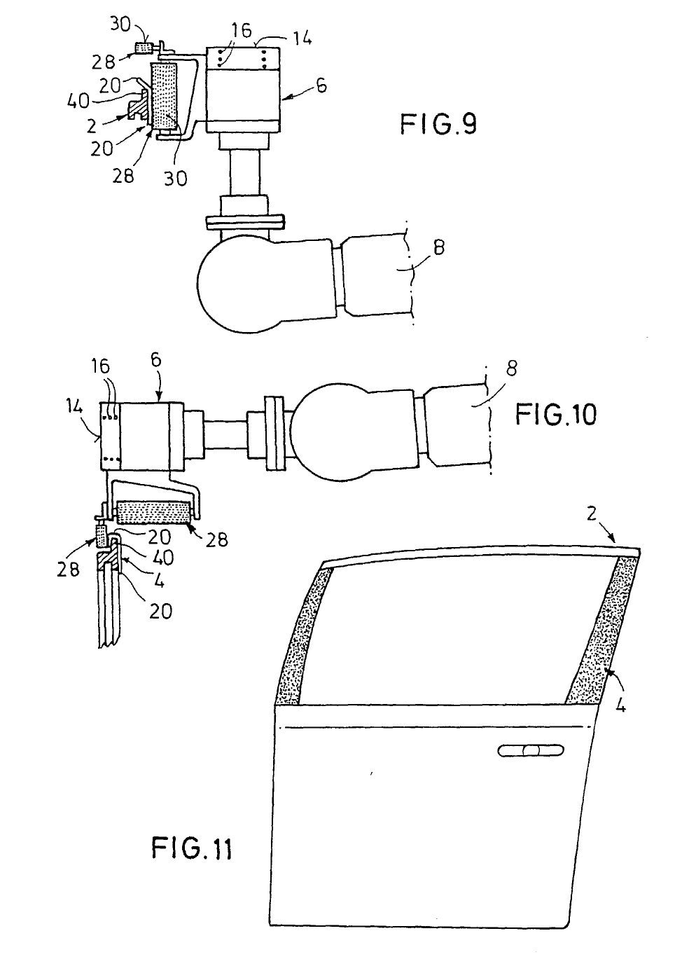

The application device 6 may additionally feature at least one pressure roller 28, mounted to rotate freely, preferably with a likewise flexible deformable covering 30. Two pressure rollers 28, of different length and width, are fastened to the application device 6 in the illustrated example. They can each be brought into a service position by properly controlled movements of the application device 6 and be guided over film sheet 4 again to press it. The dimensions (diameter, length, and width) of a respective pressure roller 28 are adapted to the respective application. A wider pressure roller 28 for rolling the entire width of film sheet 4, and a narrower pressure roller 28 for other uses, are provided in the illustrated example. See FIGS. 9 and 10 in particular.

The process in accordance with the invention will be described in more detail below.

In accordance with FIGS. 4 and 5, the respective film sheet 4 is first pre-positioned onto the convexly curved mating surface 14 of application device 6 in a defined orientation with its self-adhering backside 4a opposite its front side 4b. For this purpose, film sheet 4 can be hung onto the alignment means 14 with the positioning holes of its positioning section 22. This suspending, or pre-positioning, of the cut section of film 4 can actually also be done manually by a helper. This can preferably be accomplished through a determinately controlled fetching movement of the application device 6, wherein this device takes one film sheet 4 at a time from a magazine-like feeding station, for example. In this initially loosely hanging state starting with the alignment means 24, the wider pressure roller 28 can roll over the length of the mating surface 14 to align film sheet 4 more precisely. The actual fixing then occurs, especially by activation of the vacuum suction by means of suction holes 16, which are preferably arranged on the edges.

The positioning section 22 is then separated from the actual film sheet 4 in accordance with FIG. 5 and removed. In addition, a protective layer 32, which had been arranged on the self-adhesive coating in advance, is pulled off and removed, thereby exposing the adhesive coating. Both actions can be executed simultaneously in one operating cycle, manually for example.

In FIG. 6, the application device 6 is then moved against part 2 in the direction of the arrow 34 and pressed on lightly for the first pressing of film sheet 4 on one side (narrow-edged side). A rocking motion about the axis of swivel motion 15 thereby dynamically shifting in the direction of the arrows 15a drawn in FIG. 6 and 7 in accordance with the invention corresponding to arrow 36 in FIGS. 6 and 7 follows, so that film sheet 4 is glued on wrinkle-free by a seesawing movement. During this rolling movement, i.e. preferably right after the first contact with the adhesive in accordance with FIG. 6, the vacuum suction is deactivated. This can also occur gradually, while the rolling motion is occurring over the surface. As shown in FIG. 8, an extra rolling of the pressure roller 28 may be executed, at least locally.

In the special case of coating the region around a car pillar, it is often required that the sheet is wrapped around at least one web-like edge section 40 of car part 2 (so-called welt). In this case, pressure roller 28 rolls over edge section 40 at least once in accordance with FIGS. 9 and 10 with a determinately controlled movement in accordance with the invention, folding the corresponding remaining edge strip 20 of film sheet 4. In order to achieve a fold of approximately 180°, it is appropriate to roll over it at least twice. The relatively flexible deformability of the covering 30 of pressure roller 28 favors the wrapping. A wrinkle-free bonding can thereby also be achieved in this region.

The invention is not limited to the illustrated and described examples, but includes all embodiments that work similarly to the spirit of the invention. For example, there is an advantageous alternative to the pre-alignment of film sheet 4 on mating surface 14 that was described. It consists of the formation of alignment means on the mating surface 14 in the shape of at least punctiform bumps for resting film sheet 4 on the edges in such a manner that the sheet can be determinately positioned on the mating surface 14 at least by a three-point arrangement. The positioning section 22 and its associated alignment means 24 described above will thereby become superfluous. The operating cycle e.g., manual of separating and removing the positioning section 22 will also drop away. It is only necessary to put down the actual film sheet 4 to be glued and arrange it on the elevated alignment means. This is preferably executed manually, which also applies to the subsequent removal of the protective layer 32 after the vacuum fixation. The alignment means, which are arranged on the mating surface 14 as relatively flat or low bumps, can't get out of the way when sheet 4 is pressed because of the elasticity and flexibility of the elastic layer 26, so they won't interfere with the pressing. It is furthermore possible to press on the film section 4 at a given point of its total surface first, i.e., the starting point for positioning (top, bottom, middle . . . ) on the component being labeled can be independently selected by the independently programmable motion control. As for the rest, the invention is moreover not limited to the combination of characteristics defined in claims 1 and 7, but can also be defined by any desired other combination of particular characteristics in all of the individually disclosed characteristics as a whole. This means in principle, that practically any individual characteristic of claim 1 or 7 can be deleted and replaced by at least one individual characteristic disclosed at another place in the application. To this extent, the claims are to be understood merely as a first attempt to formulate an invention.

What is claimed is:

1. Process for positionally precise cladding of film sheets (4), with self-adhesive coatings on their backside (4a), onto parts (2) to be glued, especially car body components, whereby the respective cut section of film (4) being bent with its self-adhesive reverse side in a convex condition and pre-positioned in a defined orientation and then applied, characterized in that,
the pre-positioned cut section of film (4) is applied through a three-dimensionally defined pressure controlled application motion onto to be glued parts, in such a way that a friction-free pressing and rolling motion thereby always occurs about an axis of rotational motion (15) which progresses with the rolling motion over the surface of the component (2).

2. Process according to claim 1, characterized in that,
the respective cut section of film (4) is fixed in the defined orientation on a convex mounting surface (14) of an application mechanism (6) in particular by vacuum suction and, in particular, before that, is taken from a feed station by means of a defined controlled pick-up motion on the part of the application mechanism (6).

3. Process according to claim 2, characterized in that,
during the rolling motion, the axis of rotational motion (15) always coincides with an essentially linear zone of contact resulting between the component (2) and the convex mounting surface (14) carrying the cut section of film.

4. Process according to claim 2 or 3, characterized in that,
during the application motion, the application mechanism (6) is moved relative to the component (2) being labeled, which is locally fixed in a defined orientation.

5. Process according to claims 1 to 4, characterized in that,
the cut section of film (4) is positioned by means of particularly pin-shaped means of alignment (24) of the application mechanism (6) then fixed in place.

6. Process according to claims 1 to 5, characterized in that,
prior to the application, a protective layer (32) previously positioned on the self-adhesive coated reverse side (4a) is removed from the cut section of film.

7. Process according to one of claims 1 to 6, characterized in that,
following the application, at least one projecting edge strip (20) of cut section of film (4) is wrapped over a rib-like edge segment (40) of the component (2) being labeled, specifically and particularly by means of at least a single pass by a defined 3D-controlled motion of a pressure roller (28) over and beyond the edge segment (40).

8. Process according to claim 7, characterized in that,
the edge strip (20) is wrapped approximately 180° around the edge segment (40) by means of at least two passes of the pressure roller.

9. Device according to claim 7 or 8 and one of the claims 2 to 6, characterized in that
the cut section of film (4) on the mounting surface (14) of the application mechanism (6) is fixed by vacuum suction only in the zone of at least one edge strip (20) and particularly in the zone of at least two opposing strips (20).

10. Device for the applying of cut sections of film (4), self-adhesive coated on one side, on components (2) being labeled, particularly for the execution of the method according to one of the previous claims, consisting of an application mechanism (6) having a convex-shaped mounting surface (14) for the mounting of respective cut sections of film (4) aligned and fixed in a defined manner, characterized in that,
it is possible to move the application mechanism (6) in such a 3D-defined and mechanically controlled manner relative to the component (2) being labeled so that it is possible, by means of a clean, friction-free pressure and rolling motion, to take the cut section of film (4) from the mounting surface (14) and apply it onto the component (2) fixed in a defined orientation relative to the application mechanism (6).

11. Device according to claim 10, characterized in that
the application mechanism (6) is movable in such a way by being mechanically controlled three-dimensionally so that the rolling motion always occurs about an axis of rotational motion which progresses with the rolling motion over the component (2), whereby the progressing axis of rotational motion (15), during the rolling motion, always coincides with an essentially linear zone of contact resulting between the component (2) and the convex mounting surface (14) carrying the cut section of film (4).

12. Device according to claim 10 or 11, characterized in that
the application mechanism (6) is part of a robot arm (8) which is equipped with a programmable control unit for controlling its motion.

13. Device according to one of claims 10 to 12, characterized in that
the application mechanism (6) has means of vacuum suction for fixing the cut section of film (4).

14. Device according to claim 13, characterized in that,
the application mechanism (6) has vacuum suctin holes (16) in the region of the mounting surface (14), the suction holes being located in particular in the region of the edge strips (20) of the cut section of film (4).

15. Device according to one of the claims 10 to 14, characterized in that,
the mounting surface (16) of the application mechanism (6) is constructed of an elastically pliant layer (26).

16. Device according to one of the claims 10 to 15, characterized in that
the application mechanism (6) has at least one rotatable pressure roller (28) having a particularly elastically pliant coating.

17. Device according to one of the claims 10 to 16, characterized by means of alignment for the positionally precise, defined pre-alignment of the cut section of film (4) on the mounting surface (14).
